(19) United States
(12) Patent Application Publication
(10) Pub. No.: US 2012/0003955 A1
(43) Pub. Date: Jan. 5, 2012

(54) System and method for emergency notification from a mobile communication device

(75) Inventor: Gregory Gabriel, Meylan (FR)

(73) Assignee: LifeStream Corporation, Sherman Oaks, CA (US)

(21) Appl. No.: 12/801,922

(22) Filed: Jul. 1, 2010

Related U.S. Application Data
(63) Continuation-in-part of application No. 12/828,214, filed on Jun. 30, 2010.

(51) Int. Cl. H04W 4/22

(52) U.S. Cl. 455/404.2; 455/404.1

(57) ABSTRACT

A system and method enabling a mobile device user in an emergency to alert multiple parties to secure assistance. Using an enabled mobile communication device, a user is able to select a pre-configured emergency alert by actuating a button or icon presented on the mobile communication device. Depending on the pre-configuration, upon actuation of the alert an email is sent to a designated recipient, a phone call is placed to a designated recipient, a pre-recorded voice mail is played, and/or a text message is sent to a designated recipient. Once the emergency has passed, the user can cancel the alert which notifies the recipients of the alert messages that everything is back to normal.

### CROSS REFERENCE TO RELATED APPLICATIONS

The present patent application is a continuation-in-part of U.S. patent Ser. No. 12/828,214, filed on Jun. 30, 2010.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e): This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). The files are contained on two identical compact discs (“Copy 1” and “Copy 2”) and are in ASCII format. All of the material disclosed in the Computer Program Listing Appendix can be found at the U.S. Patent and Trademark Office archives and is hereby incorporated by reference into the present application, for all purposes.
Files: EmailUrgency ASCII.txt, size: 292864 bytes, created Jul. 1, 2010, 8:13:34 PM, contents: source code
   MyBodyGuard ASCII.txt, size: 290816 bytes, created: Jul. 1, 2010, 8:12:50 PM, Contents: source code

### FIELD OF INVENTION

The present invention is related generally to applications for mobile communications devices such as cellular telephones, personal digital assistants, media players, and the like, and more particularly, is related to applications allowing the user of a mobile communication device to contact multiple parties and summon help in an emergency.

### BACKGROUND

In the past two decades, cellular telephones have become integrated into all aspects of daily life. As cellular phones have become ubiquitous, the computational power of the devices has increased exponentially. As a result, there has been a convergence in mobile devices such that there is no meaningful distinction between cellular telephones, wireless email devices, personal digital assistants, and mobile media players. These integrated devices have processing power and functionality well beyond that of the first generations of cellular telephones and therefore, are more appropriately termed “mobile communication devices.” As used herein, a mobile communication device is any device which provides bi-directional communication over a cellular radio or wireless data network and possesses sufficient processing power to execute stored applications from the device's memory. Examples of such devices includes, but are not limited to: smartphones, (e.g., iPhone™, Android™ phones, etc.) wireless personal digital assistants (e.g., BlackBerry™, Treo™, PalmPilot™, etc.), and wireless media players (e.g. iPod Touch™).

The increased processing power and abundant user interface features of mobile communications devices provides opportunities for the design of new applications to enhance the usefulness of the devices. For example, there are many applications useful for business or entertainment. Another emerging field of applications is that of personal safety. Because mobile communications devices can be carried at all times, they provide a user the ability to call for help in an emergency from anywhere. In an emergency, a user may wish to notify multiple parties of their situation, but may not have time to place phone calls, send text messages, and send emails separately to each the parties they wish to contact. Therefore, it would be advantageous to provide methods and systems allowing a mobile communication device user to notify multiple parties of an urgent situation at the same time.

### SUMMARY OF THE INVENTION

There is a need for users of mobile communication devices to be able to contact multiple parties in an emergency and summon help. In one aspect of the present invention, a system is provided which comprises a mobile communication device capable of connecting to at least one network, wherein the device is configured to display, through a user interface, at least one emergency alert to be activated by the user in an emergency. Actuation of the emergency alert via the user interface results in a communication being sent to at least one party through the network. Upon actuation of a pre-configured alert the mobile communication device may take at least one of the following actions. If an email recipient is designated, the device sends a pre-formatted email to the designated address. The email may contain information showing the location of the device. If a phone call recipient is designated, the device places a call to the designated phone number. If more than one recipient is designated, the device may set up a conference call. If the user has pre-recorded a voice message, the device plays the voice message through the speaker of the device. If a text message recipient is designated, the device sends a pre-formatted SMS text message to the recipient. The mobile communication device may take any one of the above referenced actions independently or in combination (e.g. send an email and place a call; send an email, play a pre-recorded voice message, and send a text message; etc.).

In another aspect of the present invention, once a pre-configured alert is activated, the device waits a pre-set amount of time before taking any action. If no movement of the device is detected after the allotted time, the specified actions are taken.

In a further aspect of the present invention, the mobile communication device allows a user to easily inform designated alert recipients that the danger has passed or that the alert was a false alarm. The user may cancel the alert by selecting a cancel alert function. Upon actuation of the cancel alert function, the device may take at least one of the following actions. An alert cancellation email is sent to the designated email alert recipients. A phone call is placed to the designated phone call recipients. The pre-recorded voice message stops playing. An alert cancellation text message is sent to designated text message alert recipients.

In another aspect of the present invention, a method is described in which an emergency alert is displayed on a mobile communication device capable of connecting to a network through a user interface, and upon actuation of the alert a communication is sent from the device to another party connected through the network.

In a further aspect of the present invention, a method is described in which a user of the device is able to notify recipients of an alert message that the danger has passed or that the alert was a false alarm.

In another aspect of the present invention, a computer readable medium is provided containing computer readable instructions for performing a method allowing a user of a mobile communication device, in an emergency, to contact at least one party by selecting a preconfigured alert.

In another aspect of the present invention, a computer readable medium is provided containing computer readable instructions for performing a method allowing a user of a device to notify recipients of an alert message that the danger has passed or that the alert was a false alarm.

These and other aspects, features, and advantages of the present invention will become more apparent to those skilled in the art from the following more detailed description of the present invention when taken with reference to the accompanying drawings.

### BRIEF DESCRIPTION OF THE DRAWINGS

The details of the present invention, both as to its structure and operation, can best be understood by referring to the accompanying drawings, in which like reference numbers and designations refer to like elements. The present invention is illustrated by way of example, and not limitation, in the figures of the accompanying drawings, in which:

FIG. 1A is a representative diagram of a mobile communication device with a keypad.

FIG. 1B is a representative diagram of a mobile communication device with a track wheel and/or track ball.

FIG. 1C is a representative diagram of a mobile communication device with a touch screen.

FIG. 2 is an exemplary block diagram of a mobile communication device.

FIGS. 3A-D are examples of user interfaces through which a user can trigger and pre-configured an alert.

FIG. 4 is an exemplary diagram of a system comprising a mobile communication device capable of contacting at least one party during an emergency upon selection of a pre-configured alert.

FIG. 5 is an exemplary flow diagram of a process allowing a user to contact at least one party from a mobile communication device in an emergency.

FIG. 6 is an exemplary flow diagram of a process allowing a user to cancel a triggered alert and notify at least one party that the emergency has passed.

### DETAILED DESCRIPTION

A system and method for contacting at least one party in an emergency is disclosed. The system comprises a mobile communication device, variously a smart cellular telephone (e.g., iPhone™, Android™ phone, etc.) a wireless personal digital assistant (e.g., BlackBerry™, Treo™, PalmPilot™, etc.), a mobile media player (iPod Touch™), a portable computer, or similar device, which is configured in accordance with various embodiments of the present invention to enabled a user to automatically contact at least one party, in an emergency, upon selection of a pre-configured alert presented by a software application running on a processor of the device. As used herein, “emergency” can mean, but is not limited to, a health problem, a fire, a personal assault, an intrusion, etc. As used herein, “party” refers to any third party who is not a user of the mobile communication device on which the pre-configured alert is being selected.

In one preferred embodiment, a plurality of pre-configured alerts are presented to the user when the software application is launched on the mobile communication device. In another preferred embodiment, each of a plurality of parties are contacted by either the same or different means of communication. In another preferred embodiment, multiple alerts can be triggered successively or simultaneously.

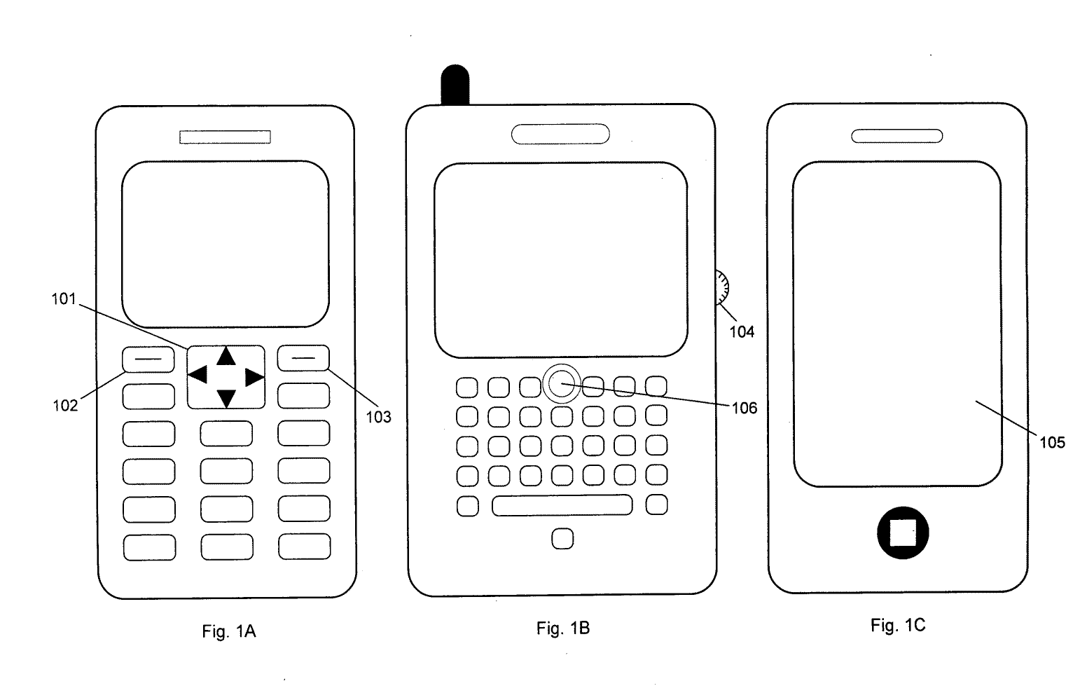

The manner in which a user selects/triggers an alert depends on the type of mobile communication device being used by the user. In one embodiment the application may be running on a mobile communication device with a keypad, a representative diagram of which is depicted in FIG. 1A. When presented with a plurality of pre-configured alerts, the user may trigger a desired alert using cursor pad 101 and softkeys 102 and 103. In another embodiment, the application may be running on mobile communication device with a track wheel 104 and/or track ball 106, a representative diagram of which is depicted in FIG. 1B. When presented with a plurality of pre-configured alerts, the user may trigger a desired alert using track wheel 104, a track ball 106, or an equivalent component. In a preferred embodiment, the application may be running on a mobile communication device with a touch screen 105, a representative diagram of which is depicted in FIG. 1C. When presented with a plurality of pre-configured alerts, the user may trigger a desired alert by touching touch screen 105 on the icon for the desired alert.

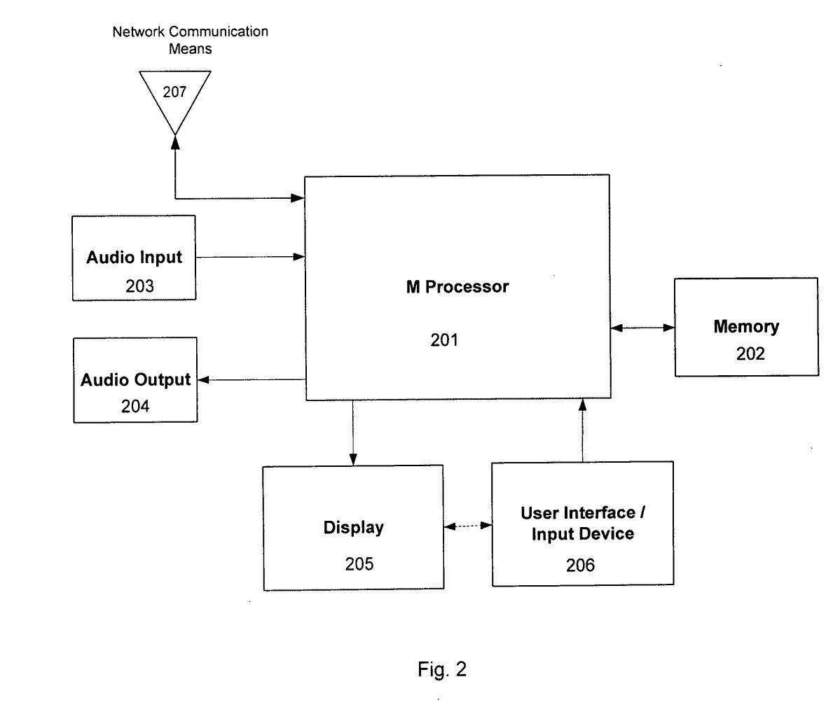

One having skill in the art will appreciate that the mobile communication devices depicted in FIGS. 1A-C are exemplary and are in no way limiting. The system and method of the present invention may be implemented by any device having a general configuration as depicted in FIG. 2.

FIG. 2 is an exemplary block diagram of a mobile communications device capable of contacting at least one party upon selection of a pre-configured alert. The device comprises a microprocessor 201 capable of running a software application allowing selection of a pre-configured alert, a memory 202, an audio input 203 (e.g. microphone), an audio output 204 (e.g. speaker), a display 205, a user interface/input device 206 (e.g. keyboard, keypad, or touch screen), and a network communication means 207. The network communication means 207 may comprise a cellular antenna for communication with CDMA, GSM, GPRS, 2G, 3G and/or 4G networks. Network communication means 207 may further comprise an antenna for communication with a wireless local access network (WLAN) using 802.11 protocols or any standard for carrying out WLAN communication. In certain embodiments of the mobile communications device, the display and user interface/input device may be integrated (e.g. touch screen devices like the iPhone™ or BlackBerry™, Storm™).

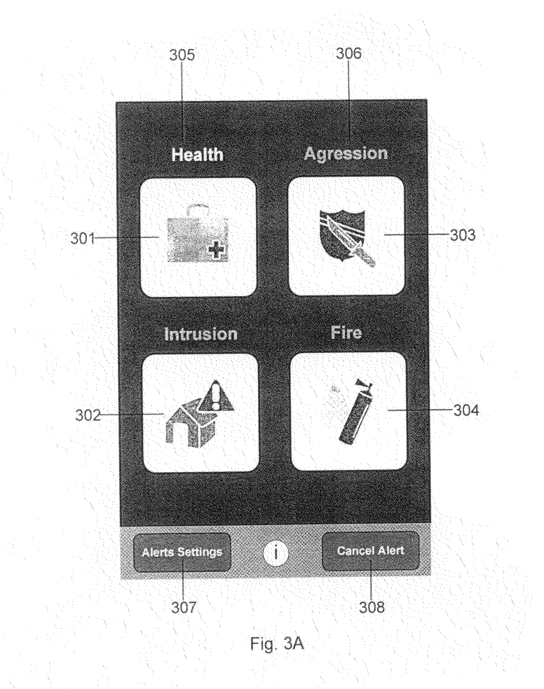

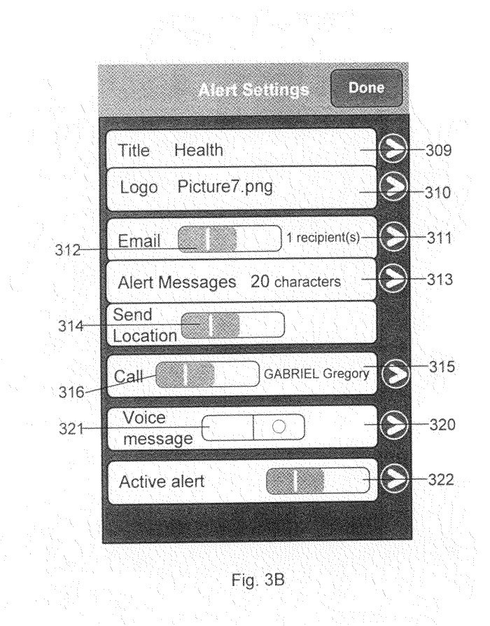

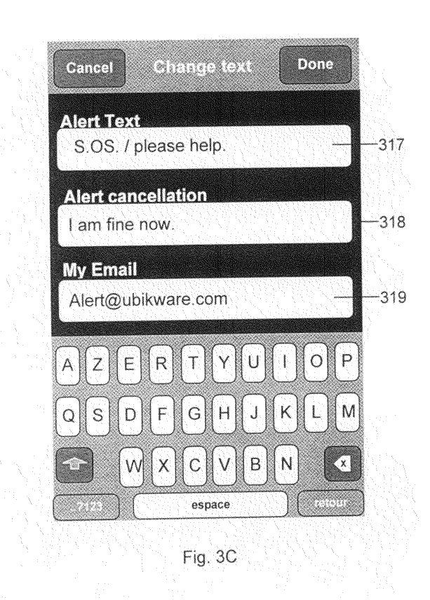

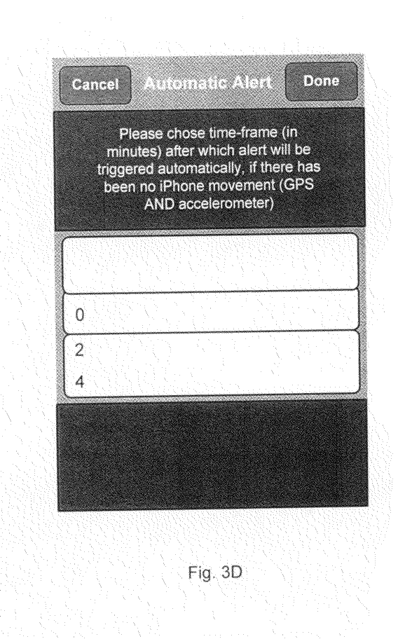

FIGS. 3A-D are exemplary user interfaces presented in certain embodiments of an enabled mobile communication device as used in the system of the present invention. The interfaces are presented by way of example and are not limiting. One having ordinary skill in the art will appreciate that the interfaces may be tailored to fit the type of mobile communication device being used. In the embodiments depicted in FIGS. 3A-D exemplary user interfaces for a touch screen mobile communication device are shown.

In FIG. 3A, one embodiment of an alert selection screen is depicted. Each alert icon 301-304 represents a pre-configured alert. In certain embodiments a plurality of alert icons are displayed. In other embodiments only one alert icon is displayed. In yet other embodiments, instead of a pictorial icon, a textual menu item is displayed. The alert icons are user customizable in that the icon picture and/or icon name may be altered.

In one preferred embodiment, when an alert is activated the name of the alert is displayed in white 305. Alerts cannot be triggered until activated. Activation is described further below. In other embodiments, activation of an alert may be indicated by altering the display of the name or icon for an alert. For example, the name or icon may be underlined or highlighted, or the name or icon may be displayed in another color such as, but not limited to, red, yellow, or green. If the alert is not activated, the name of the alert is displayed in gray 306, or another color different from one used to display an activated alert such as, but not limited to, red, yellow, or green. To trigger an activated alert, a user selects the alert by touching the icon. In other embodiments, the user selects the icon using a cursor pad 101 and softkeys 102 and 103, a track wheel 104, or a track ball 106.

In order for an alert to be activated it must be pre-configured. To pre-configure an alert, the user launches an alert settings menu by selecting the appropriate icon 307, button, or menu item. In one embodiment, the alert has a default configuration. FIG. 3B is an exemplary depiction of one embodiment of an alert settings menu. In a preferred embodiment, a user can configure an alert in the following ways.

A user can change the name of the alert by selecting the Alert Name field 309 and entering a new name. A user can change the alert icon, e.g. 301, by selecting the Alert Logo field 310 and selecting a new icon picture.

In a preferred embodiment, the user can designate an email alert recipient by selecting the Email field 311 and entering a recipient's email address. The email address is entered by selecting a contact from the address book stored on the mobile communication device. In another embodiment, the email address is entered manually via a keyboard, or keypad. In another embodiment, Email field 311 is pre-programmed with a default email address. In a preferred embodiment, more than one email recipient may be designated by entering a plurality of email addresses. In a preferred embodiment, a user specifies that an alert email should be sent to the designated email recipients when the alert is triggered by moving the slider switch 312 to the “ON” position. In one embodiment, the default position for the switch is in the “ON” position. The text of the email alert message can be altered by selecting the Alert Messages field 313. In a preferred embodiment, an exemplary embodiment of an interface is depicted in FIG. 3C. The interface allows a user to change the text of the alert email by selecting the message field 317 and entering new text. In one embodiment, a default email message is provided. In the preferred embodiment, the user is also able to change the alert cancellation email message from the interface by selecting message field 318 and entering new text. In one embodiment, a default alert cancellation email message is provided. The user may also specify their email address, as the sender's address, by inputting it into address field 319. In a preferred embodiment, the alert email can further be configured to include the location of the mobile communication device. The device determines its location using GPS, cell phone tower triangulation, or an equivalent position determining method. The position information can be communicated in the alert email. For example the email could contain textual location information. In a preferred embodiment, however, a hyper-link to a map displaying the location of the mobile communication device is embedded in the email. In another embodiment, a map displaying the device's location may be embedded in the alert email. To specify that the device's location information is to be included in an alert email, the user may move slider switch 314 to the “ON” position. In one embodiment, the default position for the switch is in the “ON” position.

In another preferred embodiment, the user may designate a call recipient by selecting the Call field 315 and entering a recipient's phone number. In one embodiment a default number in Call field 315 is provided (e.g. 911). In a preferred embodiment, a phone number is entered by selecting a contact from the address book stored on the mobile communication device. In another embodiment, the number is entered manually via a keyboard or keypad. In a preferred embodiment, more than one call recipient may be designated by entering a plurality of phone numbers. In a preferred embodiment, a user specifies that a call should be placed to the designated call recipients by moving slider switch 316 to the “ON” position. In one embodiment, the default position for the switch is in the “ON” position.

In another preferred embodiment, the user may pre-record a voice message by selecting the voice message field 320. Once the field is selected, the user will be asked to record a message using the mobile communication device's audio input 203. In one embodiment, a default voice message is provided. If voice message slider switch 321 is set to the “ON” position, when the alert is triggered, the enabled mobile communication device will play the pre-recorded voice message over the device's speaker 204. This way, if a user loses consciousness a third party who finds the user will be alerted to the situation by listening to the pre-recorded message emanating from the device. In a further embodiment the screen of the device 205 or other light on the device flashes while the message is being played. In another embodiment, a call is placed and the message is played to the call recipient. In another embodiment the pre-recorded voice message is sent as an audio file attached to an email to a designated recipient. In another embodiment, the default position for the switch is in the “ON” position.

In another embodiment, the user designates at least one SMS text recipient by entering a recipient's telephone or pager number. The telephone number may be entered manually via a keyboard or keypad or selected from the address book stored on the mobile communication device. In a preferred embodiment, multiple recipients are designated by entering a plurality of numbers. The user pre-formats the text of the SMS message by selecting a text message field and inputting a message. In one embodiment, a default text message is provided. When an alert is triggered, the enabled mobile communication device sends the pre-formatted text message to the recipients, if the text message function is activated. In a further embodiment, the text message may also include the location of the mobile communication device in a textual format, or alternatively, a hyper link to a map showing the device's location may be embedded in the message. In one embodiment, rather than sending an SMS text directly to a recipient, an email is sent to a text forwarding service which converts the email into a text message and then sends the text to a recipient.

Once all of the alert settings have been set, a user may activate the alert by moving slider switch 322 to the “ON” position. In one embodiment, the default position for the switch is in the “ON” position. In a preferred embodiment, the system comprises a logical control which prevents the user from activating an alert if no alert method has been specified. In a preferred embodiment the user may designate an alert delay such that the selected alert actions are not immediately taken by the mobile communication device when an alert is triggered. FIG. 3D depicts an exemplary user interface enabling a user to set an alert delay. When a delay is specified, instead of immediately taking the pre-configured actions, a waiting period is set, and only if there is no movement of the phone during the waiting period will the device take the specified actions. In a preferred embodiment, the device can detect movement using an on-board accelerometer, GPS, or cell phone tower triangulation. In one embodiment, a waiting period of ten seconds or greater may be designated. In another embodiment, a waiting period may be designated in increments of two minutes starting at zero minutes. If a delay period is specified, the alert icon (e.g. 301) may be altered to indicate that a delay has been specified. In one embodiment, and hourglass is displayed in the corner of the icon. In one embodiment, the default delay period is zero “0” minutes. In another embodiment, the default delay period thirty “30” seconds. In yet another embodiment, the delay period is two “2” minutes.

One having skill in the art will appreciate that the information fields in the exemplary alert settings menu may be different in alternative embodiments of the present invention. It will also be appreciated that instead of slider switches, radio buttons, check boxes, toggles and the like may be used. Further, it will be appreciated that in certain embodiments no switch is necessary to activate a specific alert action. Providing an alert recipient is sufficient. It will also be appreciated that in certain embodiments, fields, slider switches, radio buttons, check boxes, and toggles may be selected using a cursor pad 301 and softkeys 302 and 303, a track wheel 304, or a track ball 306, instead of a touch screen 305.

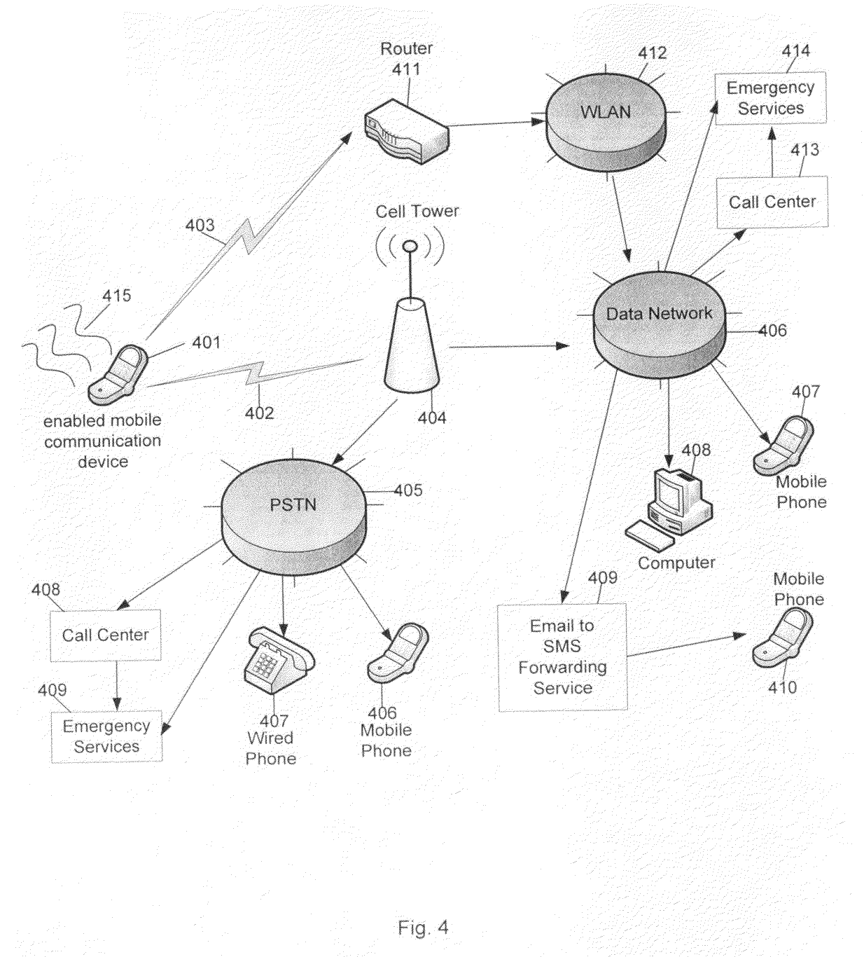

Once a pre-configured alert is triggered, the enabled mobile communication device 401 of the present invention takes at least one of the designated actions disclosed above. In a preferred embodiment, the mobile communication device 401 takes a plurality of the actions described above either sequentially or concurrently. FIG. 4 discloses a system comprising a mobile communication device 401 enabled to contact at least one party, in an emergency, when a user triggers a pre-configured alert. FIG. 4 further illustrates, by way of example, the actions taken by said device.

Once a pre-configured alert is triggered at mobile communications device 401, a wireless connection 402 or 403 is established with a network. In one embodiment, the device 401 connects to a network via a CDMA, TDMA, GSM, 2G, 3G, 4G, GPRS, and/or other wireless network connection 402. In another embodiment, the device 401 connects to a network through network connection 403 which may be via 802.11 wireless protocol and any other standard for carrying out WLAN communication. It will be appreciated that the network connections 402 and 403 are not mutually exclusive. For example, a cellular call may be placed over connection 402 while an email is transmitted over connection 403, or alternatively, a VoIP call may be placed over connection 403 while an email and/or text message is sent over connection 402.

In a preferred embodiment, a communication (variously a phone call, email, text message, and the like) transmitted over network connection 402 is received at cellular tower 404. In a preferred embodiment, a plurality of communications are transmitted from device 400 and received at cellular tower 404. At cellular tower 404, the communication or communications is/are routed to a Public Switched Telephone Network (PSTN) 405 and/or an IP Data Network 406 such as the interne or worldwide web. Examples of such routing are provided below.

In one example, a telephone call received at cellular tower 404 from device 401 is routed to PSTN 405. From PSTN 405 the call is routed to and connected with the destination number for at least one designated call recipient specified in mobile communication device 401 (see e.g. 315). The call may be connected to one or more cellular phones 406, one or more wired phones 407, a call center 408, and any other device or service capable of receiving phone calls, individually or in combination. In one embodiment, calls are set up between device 401 and the designated recipients sequentially. In another embodiment, the call is setup between device 401 and more than one designated recipient concurrently in a conference call. In one embodiment the call comprises audio only. In another embodiment, the call comprises audio and video. When the call comprises video, images captured by a video input on the user's mobile communication device are streamed to call recipients in real-time or near real-time. In a preferred embodiment the call recipients and mobile communication device user are able to talk to each other. In another embodiment, only a pre-recorded voice message is played for the call recipients.

In one embodiment, a designated call recipient may be call center 408. When the call is received at call center 408, an operator may answer the call and assist the mobile communication device user. If necessary, the operator may escalate the call to emergency services 409 including, but not limited to, 911, the police department, the fire department, a hospital, etc. In another embodiment, the call is routed directly to emergency services 409, by-passing call center 408.

In another example, a pre-configured SMS text message received at cellular tower 404 from device 401 is routed to PSTN 405. From PSTN 405, the text message is routed to the designated recipients specified on device 401. The text message may be routed to one or more cellular telephones 406, a call center 408, emergency services 409, or any combination thereof.

In another example, an email received at cellular tower 404 is routed to data network 406. From data network 406, the email is routed to one or more designated email recipients specified on device 401 (see. e.g. 411). The email may be received on at least one mobile phone 407, a computer 408, or any other device capable of viewing emails, individually or in combination. Additionally, in one embodiment, the email is routed to an SMS forwarder 409, i.e. an email-to-text message conversion service, such as, but not limited to, SMS-Mail.com™. At service 409, the email is converted into a text message and forwarded to at least one recipient 410.

In another embodiment, communications are transmitted from mobile communication device 401 over wireless network connection 403 via 802.11 protocol, or its equivalent. Exemplary communications include but are not limited to Voice-Over-Internet-Protocol (“VoIP”) calls and email. Communications transmitted over network connection 403 are received by router 411, which is in turn connected to a wireless local access network (WLAN) 412. WLAN 412 is connected to IP Data Network 406. A communication received at router 411 is routed through WLAN 412 to Data Network 406 and then to designated recipients 407-409, 413, and/or 414.

In one example, a VoIP call initiated from mobile communication device 401 upon triggering a pre-configured alert is received at router 411. The call is then routed to WLAN 412 and then to Data Network 406. From Data Network 406, the call is routed to at least one designated recipient. The call may be received at one or more cellular telephones 407, one or more computers 408, call center 413, emergency services 414, or at any other device or service capable of receiving a VoIP call, individually or in combination. In one embodiment, a user of device 401 can speak with a designated VoIP call recipient. In a further embodiment, the VoIP call contains both audio and/or video. In another embodiment, only a pre-configured voice message is played to the recipient.

One having skill in the art will appreciate that initiating a VoIP call is similar to initiating a cellular call. In a preferred embodiment, the device 401 uses network connection 402 connecting to cellular tower 404 by default.

In another example, a pre-configured email is received at router 411. The email is routed through WLAN 412 to Data Network 406. From Data Network 406, the email is sent to designated recipients. The email may be received at one or more phones or computers, at a call center 413, or at emergency services 414, individually or in combination. In a further embodiment, the email is received at SMS forwarder 409, is converted to a text message, and sent to at least one designated recipient 410.

In another preferred embodiment mobile communication device 401 plays a pre-recorded message 415 (see e.g. 320) over the device's speaker 204. In another embodiment, the display/screen or other light on the device flashes to draw attention to the device.

One having skill in the art would appreciate that FIG. 4 is a exemplary system diagram, and system components may be added or removed, as needed, without going beyond the scope of the present invention.

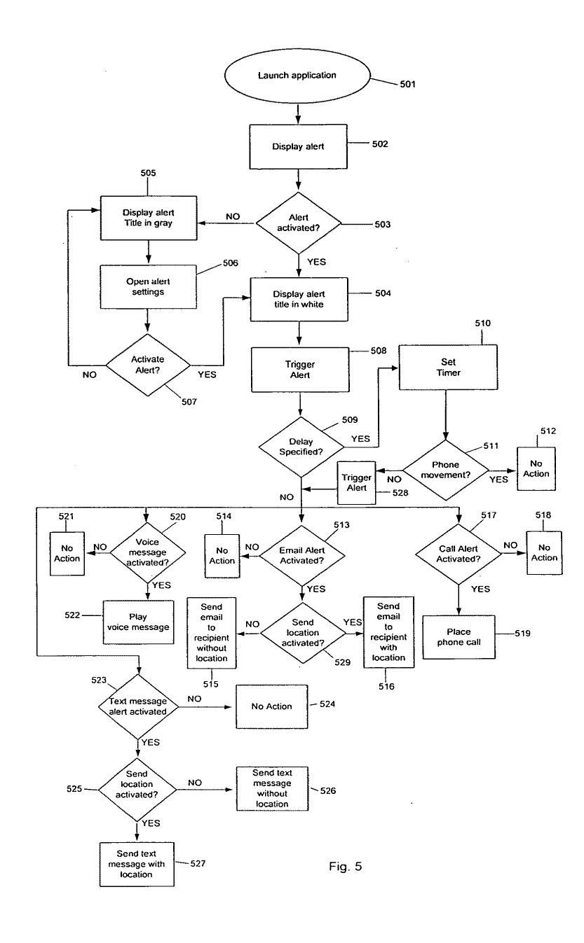

FIG. 5 is an exemplary flow diagram of an embodiment of a process implemented on a mobile communication device enabled to contact, in an emergency, at least one party. The user launches a software application on a mobile communication device at block 501. The user is then presented with an interface/display at block 502.

In preferred embodiment, the software application checks for a network connection (e.g. GSM, CDMA, TDMA, 2G, 3G, 4G, GPRS, WLAN, etc.) before presenting the user with an interface/display at block 502. If a network connection is present, the application proceeds to block 502. If no network connection is present, a message is displayed to the user informing them that an alert or cancellation cannot be sent until there is a network connection. In some embodiments, an icon is displayed rather than a message.

In one embodiment, the interface comprises a single pre-configured alert icon. In a preferred embodiment, the interface comprises a plurality of pre-configured alert icons as depicted in FIG. 4A. At block 503 a determination is made whether any alert has been activated (see e.g. 322). In one embodiment, if an alert has been activated, the alert title is displayed is displayed in white at block 504 (see e.g. 305). In one embodiment, if an alert has not been activated, the alert title is displayed in gray at block 505 (see e.g. 306). If an alert has not been activated, the user may launch an alert settings interface at block 506 (see e.g. FIG. 3B). The user may then activate the alert at block 507 (see e.g. 322). In one embodiment, if the alert is activated, the alert title is displayed in white at block 504. In one embodiment, if the alert is not activated, the alert title is displayed in gray at block 505. At block 508, the user triggers an activated pre-configured alert by selecting the icon for the alert. In a preferred embodiment, the user may trigger multiple pre-configured alerts by selecting multiple icons for activated alerts. At block 509 it is determined whether a trigger delay for the alert has been specified (see FIG. 3D). If a delay has been specified, a timer corresponding to the specified delay is set at block 510. At block 511, it is determined whether the mobile communication device has moved during the specified delay period. If the device has moved, the alert is not triggered, and no action is taken at block 512. If the device has not moved, the alert is triggered at block 528.

Once a pre-configured alert is triggered, either upon selection of an activated alert icon or after expiration of a trigger delay, at least one of the decisions at blocks 513, 517, 520, and/or 523 is made. In a preferred embodiment, more than one of the decisions at block 513, 517, 520, and/or 523 is made, and more than one type of alert communication is issued from the mobile communication device. The decisions may be made concurrently or sequentially such that multiple parties receive multiple types of communications. In certain embodiments, due to multitasking limitations of the mobile communication device's operating system, e.g. iPhone™ OS 2 or 3, there may be a limit on the number and/or combination of alert communications that can issue simultaneously. In those embodiments, a control logic may be employed to limit the number and/or combination of alert communications issued.

At block 513, it is determined whether an email alert function has been activated (see e.g. 312). If the function has not been activated then no action is taken at block 514. If the function has been activated, it is then determined at block 529 whether a send location function has been activated (see e.g. 314). If the send location function has not been activated, a pre-configured email without location information is sent to a designated recipient at block 515 (see e.g. 311). If the send location function has been activated a pre-configured email comprising location information for the mobile communication device is sent to a designated recipient at block 516. In certain embodiments, the software application determines whether GPS, or other position localization functionality, has been activated on the mobile communication device before sending an email with embedded location information. If it has, the email message is sent with the embedded location information. If it has not, a message is displayed to the user informing them that position localization functionality is not active. In a preferred embodiment, a plurality of email recipients are designated by pre-entering a plurality of email addresses such that a pre-configured email is sent to multiple parties.

At block 517, it is determined whether a call function has been activated (see e.g. 316). If the function has not been activated, no action is taken at block 518. If the function has been activated, a phone call is placed to a designated call recipient at block 519 (see e.g. 315). In a preferred embodiment, a plurality of call recipients are designated by pre-entering a plurality of telephone numbers such that a call is placed to multiple parties either sequentially or concurrently in a conference call.

At block 520, it is determined whether a voice message function has been activated (see e.g. 321). If the function has not been activated, no action is taken at block 521. If the function has been activated, a pre-recorded voice message is played over the device's speaker 205 at block 522. In another embodiment, a call is placed to one or more parties, either sequentially or concurrently, and the voice message is played. In another embodiment, the voice message audio file may be attached to an email or text message and sent to one or more designated recipients.

At block 523, it is determined whether a text message alert function has been activated. If it has not, no action is taken at block 524. If the function has been activated, it is determined whether a send location function has been activated at block 525. If it has not, a preconfigured text message without location information is sent to a designated recipient at block 526. If the send location function has been activated, a preconfigured text message comprising location information for the mobile communication device is sent to a designated recipient at block 527. In a preferred embodiment, a plurality of text message recipients are designated by pre-entering a plurality of cellular telephone or pager numbers such that a pre-configured text message is sent to multiple parties either sequentially or concurrently.

In a preferred embodiment, before any action is taken at steps 515, 516, 519, 526, and/or 527 the software application determines whether a network connection is present. If a network connection is present, the action is taken, i.e. the call is placed, the email is sent, the text message is sent, etc. If a network connection is not present, the user is informed by a message, icon, or other display indicating that the call could not be placed, or that the email or text message could not be sent. The pre-recorded voice message can play at 522 independent of a network connection, and if activated, will be played regardless of whether any action is taken as described in blocks 515, 516, 519, 526, and/or 527.

One having skill in the art will appreciate that based on preference or device limitations, steps may be added to or deleted from the process disclosed in FIG. 5 and still be in accordance with the present invention.

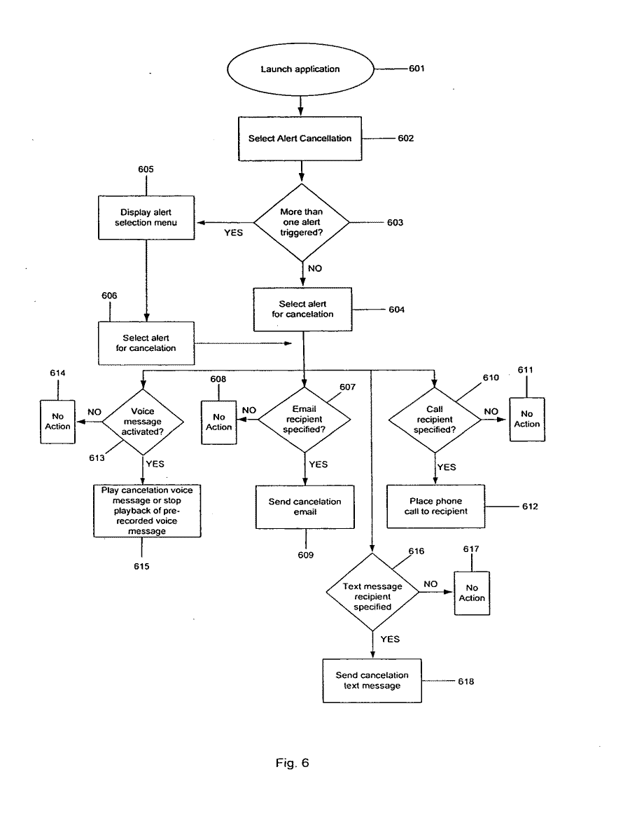

FIG. 6 is an exemplary flow diagram of an embodiment of a process implemented on an enabled mobile communication device allowing a user to easily notify emergency alert recipients that the danger has passed or that the alert was a false alarm. The user launches a software application mobile communication device at block 601. At block 602, the user selects an alert cancellation function (see e.g. 308). At block 603 it is determined whether more than one pre-configured alert has been triggered. If only one pre-configured alert has been triggered, the user selects that alert for cancellation at block 604. If more than one alert has been triggered, the user is asked to chose which alert to cancel at block 605. In a preferred embodiment, the software application checks for a network connection before presenting the user with an interface. If no network connection is present, a message is displayed to the user informing them that an alert or cancellation cannot be sent until there is a network connection. In some embodiments, an icon is displayed rather than a message. In another embodiment, once a connection is reestablished the alert or cancellation is sent. At block 606, the user selects which alert to cancel. In certain embodiments the user can cancel multiple alerts or all alerts sequentially or concurrently without exiting the application. In another embodiment, the user is required to enter an optional pin code to cancel the alerts. Once the user has selected an alert for cancellation, at least one of the decisions at blocks 607, 610, 613, and/or 616 is made. In a preferred embodiment, more than one of the decisions at blocks 607, 610, 613, and/or 616 is made, and more than one type of alert cancellation communication is issued. The decisions may be made concurrently or sequentially such that a plurality of parties are contacted by a plurality of communication methods.

At block 607 it is determined whether the email alert function was activated. If the function was not activated, no action is taken at block 608. If the function was activated a pre-formatted cancellation email is sent to the designated email alert recipients at block 609 (see e.g. 318). In certain embodiments a default cancellation message is provided. At block 610 it is determined whether the call function was activated. If the function was not activated, no action is taken at block 611. If the function was activated, a call is placed to the designated call recipients either sequentially or concurrently in a conference call at block 612. At block 613 it is determined whether the voice message function was activated. If the function was not activated, no action is taken at block 614. If the function was activated, playback of the voice message is stopped at block 615. In another embodiment, a call is placed to designated recipients, and a pre-recorded cancellation message is played At block 616 it is determined whether the text message alert function was activated. If the function was not activated, no action is taken at block 617. If the function was activated, a preconfigured cancellation text message is to sent the designated text message recipients at block 618. In certain embodiments a default cancellation email is provided.

One having skill in the art will appreciate that based on preference or device limitations steps may be added to or deleted from the process disclosed in FIG. 6 and still be in accordance with the present invention.

In addition to the embodiments described above, the files provided in the accompanying Computer Program Listing Appendix, hereby incorporated by reference, contain lines of computer code representing other preferred embodiments of the present invention.

In accordance with the systems, and methods of the present invention, a further embodiment comprises a computer readable medium comprising computer readable instructions for performing a method allowing a user of a mobile communication device, in an emergency, to contact at least one party by selecting a preconfigured alert. In a further embodiment, the computer readable medium also comprises computer readable instructions allowing a user of a mobile communications device to easily notify emergency alert recipients that the danger has passed or that the alert was a false alarm. The computer readable medium can be a compact disc, a hard drive, flash memory, RAM, ROM, SDRAM, and the like.

Although several embodiments of the present invention and its advantages have been described in detail, it should be understood that mutations, changes, substitutions, transformations, modifications, variations, and alterations can be made without departing from the teachings, spirit, and scope of the present invention set forth in the claims below.

What is claimed is:

1. A system for contacting at least one party during an emergency comprising:
a mobile communication device capable of connecting to at least one network, the mobile communication device configured to display, through a user interface, an emergency alert, wherein actuation of the emergency alert via the user interface results in a communication being sent from the device to at least one other party connected through the network.

2. The system of claim 1, wherein a plurality of alerts are displayed through the user interface.

3. The system of claim 1, wherein the alert is pre-configured.

4. The system of claim 1, wherein if the mobile device is not connected to at least one network, upon actuation of the emergency alert, a notice is displayed that there is no network connection.

5. The system of claim 1, wherein the communication resulting from actuation of the emergency alert comprises at least one email to at least one designated email recipient.

6. The system of claim 5, wherein the mobile communication device is capable of determining its location and the email further comprising the location information of the mobile communication device.

7. The system of claim 5, wherein the at least one of the designated email recipients comprises an SMS text forwarding service.

8. The system of claim 1, wherein the communication resulting from actuation of the emergency alert comprises a phone call placed to at least one designated recipient.

9. The system of claim 8, wherein a conference call is set up between the user and a plurality of designated call recipients.

10. The system of claim 1, wherein the communication resulting from actuation of the emergency alert comprises at least one text message to at least one designated SMS text message recipient.

11. The system of claim 1, wherein the communication resulting from actuation of the emergency alert comprises one or more of an email, a phone call, and a SMS text message.

12. The system of claim 1, wherein the mobile communication device is further configured to play a pre-recorded voice message through a speaker of the device upon actuation of the emergency alert.

13. The system of claim 1, wherein no communication is sent after actuation of the emergency alert until a pre-set amount of time has passed.

14. The system of claim 1, wherein the mobile communication device is further capable of sending a communication through the network to at least one party that the emergency alert has been cancelled.

15. A method for contacting at least one party during an emergency comprising the steps of:
displaying an emergency alert, through a user interface, on a mobile communication capable of connecting to at least one network;
actuating the alert via the user interface; and
sending a communication from the device to at least one other party connected through the network.

16. The method of claim 15, wherein more than one alert is displayed through the user interface.

17. The method of claim 15, wherein if the mobile device is not connected to at least one network, upon actuation of the emergency alert, a notice is displayed that there is no network connection.

18. The method of claim 15, wherein the communication sent from the device comprises an email to a designated recipient.

19. The method of claim 15, wherein the communication sent from the device comprises a phone call placed to a designated recipient.

20. The method of claim 15, wherein the communication sent from the device comprises an SMS text message to a designated recipient.

21. The method of claim 15, wherein the communication sent from the device comprises one or more of an email, a phone call, and a SMS text message.

22. A computer readable medium comprising computer readable instructions for performing a method comprising the steps of:
displaying an emergency alert, through a user interface, on a mobile communication capable of connecting to at least one network;
actuating the alert via the user interface; and
sending a communication from the device to at least one other party connected through the network.
